(19) United States
(12) Patent Application Publication
(10) Pub. No.: US 2025/0293586 A1
(43) Pub. Date: Sep. 18, 2025

(54) METHOD TO OPTIMALLY SYNCHRONIZE SWITCHING PULSES OF PARALLEL CONNECTED CONVERTERS WITHOUT ANY COMMUNICATION

(71) Applicant: HANWHA SOLUTIONS CORPORATION, Seoul (KR)

(72) Inventors: Ivan PETRIC, Santa Clara, CA (US); Milan ILIC, Santa Clara, CA (US)

(73) Assignee: HANWHA SOLUTIONS CORPORATION, Seoul (KR)

(21) Appl. No.: 19/222,605

(22) Filed: May 29, 2025

Related U.S. Application Data
(63) Continuation-in-part of application No. 18/775,266, filed on Jul. 17, 2024.
(60) Provisional application No. 63/558,521, filed on Feb. 27, 2024.
(60) Provisional application No. 63/725,652, filed on Nov. 27, 2024.

(51) Int. Cl. H02M 1/15; H02M 7/48; H02M 7/493; H02M 7/537

(52) U.S. Cl. CPC H02M 1/15; H02M 7/4815; H02M 7/493; H02M 7/537

(57) ABSTRACT

A power converting system may include a plurality of power converting devices electrically connected to each other in parallel, each of the plurality of power converting devices including at least one switching node and connected to at least one capacitor, and a plurality of controllers each connected to the plurality of power converting devices, each of the plurality of controllers configured to, sample a targeted local electrical signal measurement associated with an electrical signal of the plurality of power converting devices over a desired time period, obtain a cost function value based on the samples of the targeted local electrical signal measurement, obtain a phase perturbation value associated with the at least one switching node of the connected power converting device, and adjust a switching pulse phase of the connected power converting device based on the cost function value and the phase perturbation value.

### CROSS-REFERENCE TO RELATED APPLICATION

This U.S. non-provisional application claims the benefit of priority from U.S. Provisional Application No. 63/725,652, filed on Nov. 27, 2024, in the USPTO, the entire disclosure of which is incorporated by reference herein. Additionally, this U.S. non-provisional application is a continuation-in-part and claims the benefit of priority to U.S. patent application Ser. No. 18/775,266, filed on Jul. 17, 2024, in the USPTO, which claims the benefit of priority to U.S. Provisional Application No. 63/558,521, filed on Feb. 27, 2024, in the USPTO, the entire disclosures of each of which are incorporated by reference herein.

### BACKGROUND

Various example embodiments relate to a method for synchronizing switching pulses of parallel connected power converter devices without communication between the power converter devices, systems including the same, and/or apparatuses for performing the same. For example, the method may provide improved and/or optimal synchronization of the switching pulses of parallel-connected power converters, such as voltage source converters (VSCs), photovoltaic (PV) inverters, power factor correction (PFC) rectifiers, etc., without communication between the power converters.

In power converting systems, such as PV systems, residential battery systems, commercial energy storage systems, or the like, a plurality of power converting devices are electrically connected in parallel, e.g., at their input ports, output ports, or both, to form one electrical grid-connected terminal which outputs power to, or receives power from, the electrical grid as a combined unit. Because multiple power converting devices (e.g., power inverters, etc.) are connected in parallel, lower current-rated components may be used for the individual power converting device in comparison to a similar system including a single power converting device, thereby reducing the current stress placed on each individual power converting device, and increasing the reliability of the power converting system. This further results in a reduction of overall system cost and size. However, parallel connection of the power converter devices results in the summation of the currents of the individual power converters, which leads to enlarged current or voltage ripples in the power being output by the plurality of power converting devices if the power converting devices are not properly synchronized, which increases conduction losses, power loss, and/or inefficiency in the power converting system. While the use of larger filters, e.g., larger inductors and/or capacitors, may reduce the size of the current or voltage ripples of the power converting system, the larger filters increase the cost, size, and/or weight of the power converting system.

### SUMMARY

At least one example embodiment relates to a power converting system.

In at least one example embodiment, the power converting system may include, a plurality of power converting devices electrically connected to each other in parallel, each of the plurality of power converting devices including at least one switching node and each of the plurality of power converting devices connected to at least one capacitor, and a plurality of controllers each connected to the plurality of power converting devices, each of the plurality of controllers configured to, sample a targeted local electrical signal measurement associated with an electrical signal of the plurality of power converting devices electrically connected to each other in parallel over a desired time period, obtain a cost function value associated with the plurality of power converting devices electrically connected to each other in parallel based on the samples of the targeted local electrical signal measurement, obtain a phase perturbation value associated with the at least one switching node of the connected power converting device, and adjust a switching pulse phase of the connected power converting device based on the cost function value and the phase perturbation value.

Some example embodiments provide that the targeted local electrical signal measurement is a measurement of a voltage ripple of the at least one capacitor of the plurality of power converting devices.

Some example embodiments provide that the system may further include, a filter connected to the at least one capacitor of the plurality of power converting devices, the filter configured to remove a DC-bias from the electrical signal, and each of the plurality of controllers are further configured to sample the filtered electrical signal.

Some example embodiments provide that the targeted local electrical signal measurement is a measurement of a current ripple of the at least one capacitor of the plurality of power converting devices.

Some example embodiments provide that each of the plurality of power converting devices include at least one output port, and the plurality of power converting devices are electrically connected to each other in parallel at the at least one output ports.

Some example embodiments provide that each of the plurality of power converting devices include at least one input port, and the plurality of power converting devices are electrically connected to each other in parallel at the at least one input ports.

Some example embodiments provide that each of the plurality of power converting devices include at least one output port and at least one input port, and the plurality of power converting devices are electrically connected to each other in parallel at the at least one output ports and the at least one input ports.

Some example embodiments provide that each controller of the plurality of controllers is further configured to adjust the switching pulse phase of the connected power converting device by, multiplying the cost function value with the phase perturbation value, filtering results of the multiplication, and performing compensation on results of the filtering.

Some example embodiments provide that each controller of the plurality of controllers is further configured to perform compensation on the filtered and demodulated cost function value by performing at least one of, integral control on the results of the filtering, proportional control on the results of the filtering, proportional-integral control on the results of the filtering, proportional-integral-derivative control on the results of the filtering, non-linear control on the results of the filtering, or any combinations thereof.

Some example embodiments provide that each controller of the plurality of controllers is further configured to filter the results of the multiplication using at least one of, a moving average filter, a low-pass filter, a notch filter, a bandpass filter, or any combinations thereof.

Some example embodiments provide that each controller of the plurality of controllers is further configured to adjust the switching pulse phase of the connected power converting device by, determining a total phase shift associated with the at least one switching node of the connected power converting device based on the phase perturbation value and results of the compensating.

Some example embodiments provide that each controller of the plurality of controllers is further configured to adjust the switching pulse phase of the connected power converting device by, adjusting the switching pulse phase of at least one terminal of the connected power converting device based on the determined total phase shift.

Some example embodiments provide that each controller of the plurality of controllers is further configured to adjust the switching pulse phase of the connected power converting device by, obtaining a previous switching pulse phase of the at least one terminal of the connected power converting device, and adjusting the switching pulse phase of the at least one terminal of the connected power converting device based on the determined total phase shift and the obtained previous switching pulse phase.

Some example embodiments provide that the plurality of controllers is equal to N controllers, wherein N is an integer greater than or equal to 1, the plurality of power converting devices is equal to N power converting devices, and the system further comprises, an N+1th power converting device connected to the plurality of power converting devices, the N+1th power converting device including at least one N+1th switching node, and an N+1th controller connected to the N+1th power converting device, the N+1th controller configured to provide a fixed switching pulse phase to the at least one N+1th switching node.

Some example embodiments provide that the plurality of power converting devices are at least one of, voltage source converters, voltage source inverters, current source inverters, AC-DC converters, DC-DC converters, DC-AC converters, AC-AC converters, or any combinations thereof.

Some example embodiments provide that the system may further include, a plurality of photovoltaic (PV) modules connected to a corresponding power converting device of the plurality of power converting devices, each of the PV modules configured to, harvest solar energy, and output the harvested solar energy as direct current (DC) power to the corresponding power converting device, and each of the plurality of controllers are further configured to, sample the targeted local electrical signal measurement associated with the plurality of power converting devices from the DC power.

At least one example embodiment relates to a method of operating a power converting system.

In at least one example embodiment, the method may include, sampling a targeted local electrical signal measurement associated with an electrical signal of a plurality of power converting devices over a desired time period, the plurality of power converting devices electrically connected to each other in parallel, each of the plurality of power converting devices including at least one switching node and each of the plurality of power converting devices connected to at least one capacitor, obtaining a cost function value associated with the plurality of power converting devices electrically connected to each other in parallel based on the samples of the targeted local electrical signal measurement, obtaining phase perturbation values associated with each of the at least one switching nodes of the plurality of power converting devices, and adjusting a switching pulse phase of each power converting device of the plurality of power converting devices based on the cost function value and the phase perturbation value associated with the power converting device.

Some example embodiments provide that the adjusting the switching pulse phase of each of the power converting devices further includes, multiplying the cost function value associated with each of the power converting devices using the phase perturbation value associated with the power converting device, filtering results of the multiplying associated with each of the power converting devices, and performing compensation on results of the filtering associated with each of the power converting devices.

Some example embodiments provide that the adjusting the switching pulse phase of each power converting device of the plurality of the power converting devices further includes.

At least one example embodiment relates to a photovoltaic (PV) power converting system.

In at least one example embodiment, the system may include, a plurality of power converting devices connected to a plurality of photovoltaic (PV) modules, the plurality of power converting devices electrically connected to each other in parallel, each of the plurality of power converting devices including at least one switching node and each of the plurality of power converting devices connected to at least one capacitor, and a plurality of controllers each connected to the plurality of power converting devices, each of the plurality of controllers configured to, sample a targeted local electrical signal measurement associated with an electrical signal of the plurality of power converting devices electrically connected to each other in parallel over a desired time period, obtain a cost function value associated with the plurality of power converting devices electrically connected to each other in parallel based on the samples of the targeted local electrical signal measurement, obtain a phase perturbation value associated with the at least one switching node of the connected power converting device, and adjust a switching pulse phase of the connected power converting device based on the cost function value and the phase perturbation value.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1A illustrates an example power converting system including a plurality of power converting devices connected in parallel at their output ports according to at least one example embodiment;

FIG. 1B illustrates an example power converting system including a plurality of power converting devices connected in parallel at their input ports according to at least one example embodiment;

FIG. 1C illustrates an example power converting system including a plurality of power converting devices connected in parallel at their input ports and output ports according to at least one example embodiment;

FIG. 2 illustrates an example power converting device of the example power converting system of FIGS. 1A to 1C according to some example embodiments;

FIGS. 3A and 3B are example timing diagrams illustrating the effect of phase synchronization of power converting devices on an output current according to some example embodiments;

FIG. 4A illustrates an example functional block diagram of the controller of the power converting device according to some example embodiments;

FIG. 4B illustrates a voltage ripple sensing circuit according to some example embodiments;

FIG. 4C illustrates a current ripple sensing circuit according to some example embodiments;

FIG. 4D illustrates an example functional block diagram of the power converting system according to some example embodiments;

FIGS. 5A and 5B are flowcharts illustrating an example method of operating the power converting system according to at least one example embodiment; and

FIG. 6 is an example timing diagram for a PWM control signal according to at least one example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware.

Various example embodiments relate to a method for synchronizing switching pulses of parallel connected power converter devices without communication between the power converter devices, systems including the same, and/or apparatuses for performing the same.

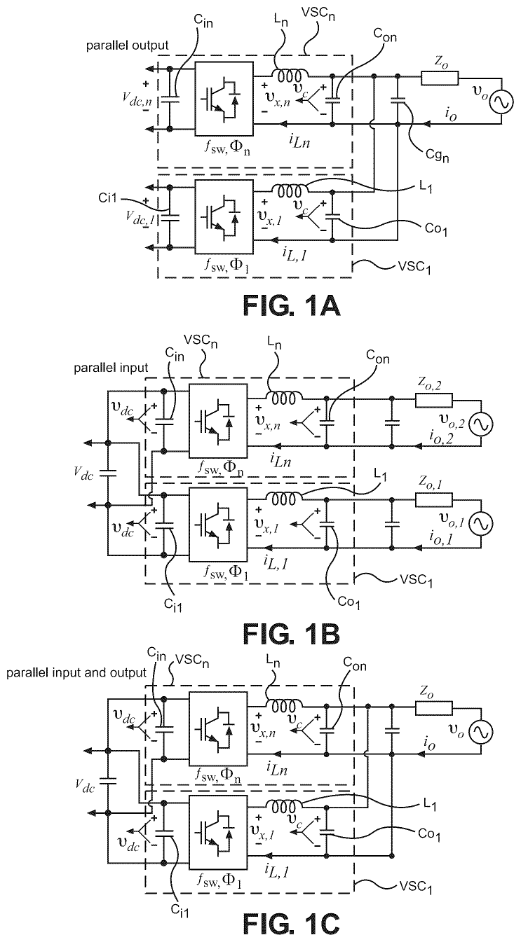

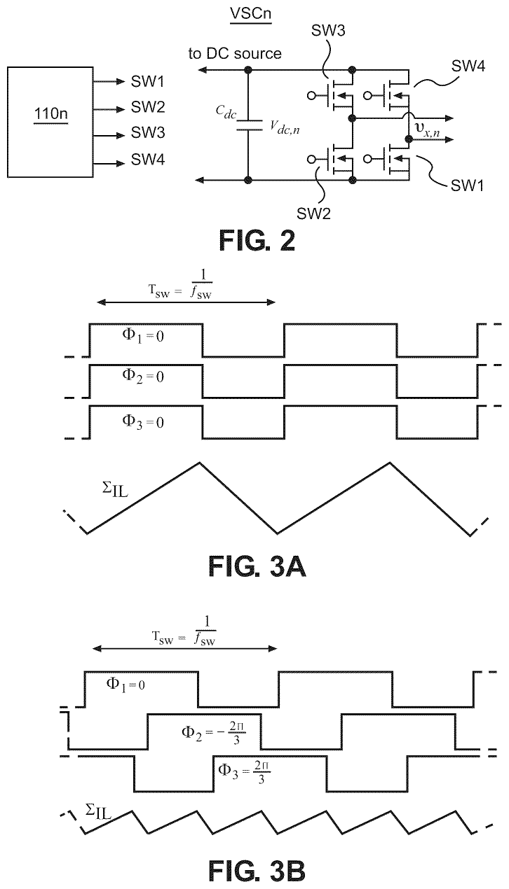

FIG. 1A illustrates an example power converting system including a plurality of power converting devices connected in parallel at their output ports according to at least one example embodiment. FIG. 1B illustrates an example power converting system including a plurality of power converting devices connected in parallel at their input ports according to at least one example embodiment. FIG. 1C illustrates an example power converting system including a plurality of power converting devices connected in parallel at their input ports and output ports according to at least one example embodiment. FIG. 2 illustrates a power converting device of the example power converting system of FIG. 1. FIGS. 3A and 3B are example timing diagrams illustrating the effect of phase synchronization of power converting devices on an output current according to some example embodiments.

Referring now to FIG. 1A, a power converting system may include a plurality of power converting devices connected in parallel at their output ports, such as a plurality of power converting devices may be voltage source converters (VSCs) VSC1 and VSCn, where n is an integer, but the example embodiments are not limited thereto, and for example, one or more of the power converting devices may be voltage source inverters, current source inverters, AC-DC converters, DC-DC converters, DC-AC converters, and/or AC-AC converters, etc., but are not limited thereto.

As shown in FIG. 1A, the plurality of power converting devices VSC1 and VSCn, may be connected in parallel to each other at their outputs, and may further be connected in series to a grid capacitor Co, a grid filter Zo, and/or a grid voltage source Vo, but is not limited thereto. In some example embodiments, the grid capacitor Cg may represent a grid capacitor for filtering the current output by the power converting devices VSC1 to VSCn, the grid filter Zo may represent a grid filter (e.g., a passive filter, etc.) and/or a grid impedance connected to an electrical grid, and the grid voltage source Vo may represent an external power source, such as the line voltage of the electrical utility grid, etc., but the example embodiments are not limited thereto. According to some example embodiments, the power converting devices VSCs also include one or more output filters (e.g., the capacitors Co1 to Con, etc.) for filtering the current ripple output by the respective power converting devices VSC1 to VSCn, but the example embodiments are not limited thereto.

Each of the power converting devices VSC1 to VSCn may be connected to a voltage source Vdc, e.g., Vdc1 to Vdcn, but are not limited thereto. For example, the voltage sources Vdc1 to Vdcn may be photovoltaic (PV) modules for harvesting PV energy (e.g., solar energy) using PV cells, but are not limited thereto. The power converting devices VSC1 to VSCn may convert direct current (DC) electricity output by the PV modules Vdc to Vdcn into alternating current (AC) electricity and may output the AC electricity through Vx1 to Vxn to the electrical grid. Because the plurality of power converting devices are connected in parallel, the switched node voltages output by each of the plurality of power converting devices (e.g., Vx1 to Vxn) are the same for the entire circuit, while the currents output by each of the power converting devices are summed together. Additionally, each VSC may include an inductor, e.g., inductors L1 to Ln, etc., which may filter (e.g., decrease and/or eliminate) high switching ripples in the output power. Moreover, when the output ports of the VSCs are connected in parallel, the current ripples are summed together, thereby increasing the current ripple which must be filtered by the capacitors and/or other filters of the system. Further, the output capacitors (e.g., Co1, Con, etc.) must have a high RMS rating, e.g., an RMS rating equal to or greater than the sum of the current ripples, in order to filter the current ripples in the system without being damaged. Consequently, the costs and/or losses of the system are increased and the lifetime of the system, particularly of the filters, is decreased due to the higher magnitude current ripples.

Referring now to FIG. 1B, according to some example embodiments, a power converting system may include a plurality of power converting devices which are connected in parallel at their input ports. For example, each of the plurality of power converting devices VSC1 to VSCn also include input capacitors Ci1 to Cin for filtering the current ripple at that port, but are not limited thereto. Further, as shown in FIG. 1B, the input capacitors Ci1 to Cin for the plurality of power converting devices VSC1 to VSCn may be connected in parallel to another capacitor (at the point of coupling). Additionally, according to some example embodiments, a power converting system may include a plurality of power converting devices which are connected in parallel at their input ports and their output ports. As shown in FIG. 1C, the input capacitors Ci1 to Cin for the plurality of power converting devices VSC1 to VSCn are connected in parallel at the input port (sharing the voltage Vdc), and the output capacitors Co1 to Con for the plurality of power converting devices VSC1 to VSCn are connected in parallel at the output ports. The parallel connection of the input ports and/or output ports of the plurality of power converting devices may be a design choice chosen by the manufacturer and/or operator of the power converting system.

While FIGS. 1A to 1C illustrate two power converting devices in each system, the example embodiments are not limited thereto, and there may be three or more power converting devices (e.g., power converters, etc.) included in the respective systems. Additionally, while FIGS. 1A to 1C illustrate single-phase power converting systems, the example embodiments are not limited thereto, and the power converting systems may be multi-phase power converting systems, e.g., a three-phase systems, etc.

Referring now to FIGS. 1A to 1C and FIG. 2, a power converting device, such as VSCn of any one of FIGS. 1A to 1C, may include a capacitor Cdc, which may correspond to the input and/or output capacitors for the power converting device VSCn, and/or at least one switch, such as switches SW1 to SW4, etc., but the example embodiments are not limited thereto, and for example, there may be a greater or lesser number of capacitors and/or switches included in the power converting device VSCn. The input and/or output capacitor Cdc may be connected in parallel to the terminals of the voltage source Vdc, e.g., a PV module, etc., and may store energy from the voltage source Vdc when the power converting system is in a first mode, and/or may output energy to the voltage source Vdc when the power converting system is in a second mode. The capacitor Cdc may be connected in parallel to one or more switching legs, e.g., SW2 and SW3 and/or SW1 and SW4, etc., which may be connected to the terminal of the power converting device VSCn, and the power converting device VSCn outputs a voltage Vxn at a current I.

For example, the terminal of the power converting device VSCn may be connected to the remainder of the electrical circuit of the power converting system of FIGS. 1A to 1C, and the switches SW1 to SW4 of the power converting device VSCn may control the output of the energy stored in the capacitor Cdc and/or the voltage source Vdc to the inductor Ln and/or the capacitor Cn, as well as the electrical grid (e.g., the grid capacitor Co, the grid filter Zo, and/or the grid voltage source Vo, etc.) and/or may control the input of energy from the electrical grid to the capacitor Cdc and/or the voltage source Vdc (as shown in FIGS. 1B and 1C), but the example embodiments are not limited thereto. Additionally, the power converting device VSCn may further include a controller 110n (e.g., processing circuitry, processor, microcontroller, etc.) for controlling the operation of the power converting device VSCn, and more specifically, for controlling and/or adjusting the phase of the switching signal (e.g., the phase of the switching voltage, the phase of the switched-node voltage, and/or the phase of the PWM signal, etc.) of the at least one switch of the power converting device VSCn. The controller 110n may be implemented as processing circuitry, and the processing circuitry may include hardware or hardware circuit including logic circuits; a hardware/software combination such as a processor executing software and/or firmware; or a combination thereof. For example, the processing circuitry more specifically may include (and/or be included in) a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto. According to some example embodiments, the controller 110n may be separate from and/or external to the VSCn and instead may be communicatively connected to the VSCn such that the controller 110n controls the opening and closing of the plurality of switches, e.g., SW1 to SW4, and/or obtains measurements of the electrical signals of the electrical circuit, etc.

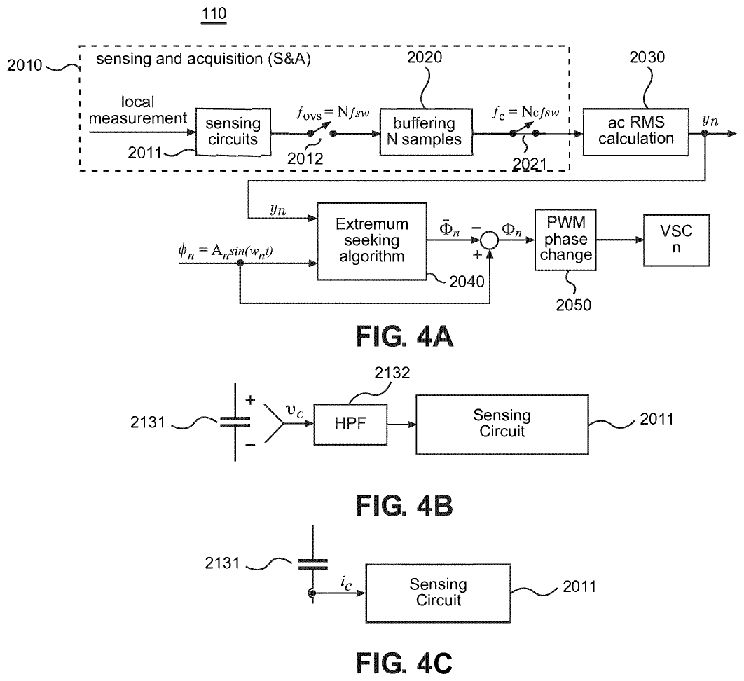

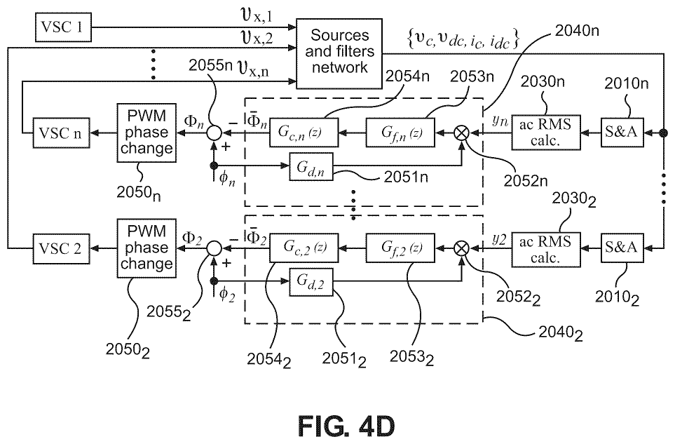

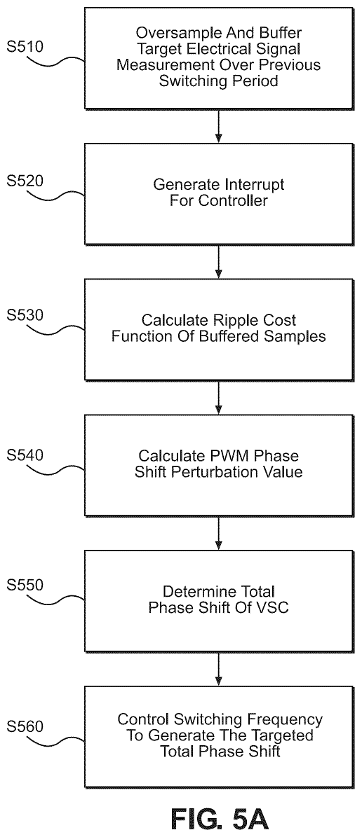

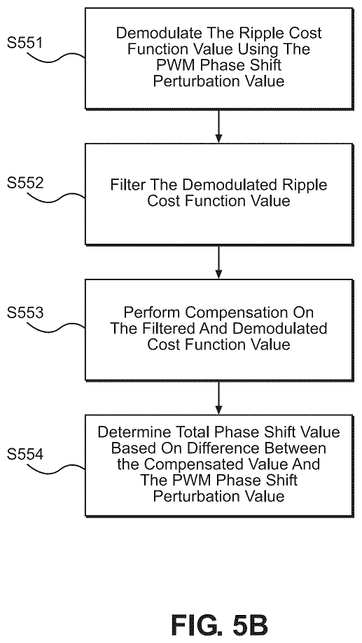

Additionally, the controller 110n and/or the power converting device VSCn may include memory (not shown) which may include computer-readable program code stored in a non-transitory computer-readable medium. The computer-readable program code may be provided to a variety of computers or processors of other data processing devices. The term “non-transitory,” as used herein, is a description of the medium itself (e.g., as tangible, and not a signal) as opposed to a limitation on data storage persistency (e.g., volatile memory vs. non-volatile memory, etc.). For example, the non-transitory computer-readable recording medium may be any tangible medium that can store or include the program in or connected to an instruction execution system, equipment, and/or device, and may include a random access memory (RAM), a read only memory (ROM), and/or a non-volatile mass storage device, such as a disk drive, and/or a solid state drive, etc. The memory may include, for example, special purpose and/or custom computer readable instructions to be executed by the controller 110n, etc. In at least some example embodiments, such computer readable instructions may be loaded from a non-transitory computer-readable storage medium independent of the memory, using a flash memory device, etc. (not illustrated). For example, the memory may include various special purpose program code including the computer executable instructions which may cause the controller 110n to perform one or more of the methods of the example embodiments, such as special purpose program code associated with the operations to be discussed in greater detail in connection with FIGS. 4A to 5B, etc.

Additionally, the controller 110n is configured to execute processes by retrieving the program code (e.g., the computer readable instructions) and data from the memory to process them, thereby executing special purpose control and functions of the entire power converting device VSCn. Once the special purpose program instructions are loaded into the controller 110n, the controller 110n executes the special purpose program instructions, thereby transforming the controller 110n into a special purpose processor, for example, a special purpose processor to perform one or more of the methods described below in connection with FIGS. 4A to 5B.

In at least one example embodiment the controller 110n and the memory may be integrated, e.g., as a printed circuit board assembly (PCBA), a system-on-chip, and/or the like. In other words, the controller 110n and the memory may be combined into a single component, but the example embodiments are not limited thereto.

Ripples in the current output by the parallel-connected plurality of power converting devices VSC1 to VSCn may change due to clock drift in system clocks (not shown) included in the controllers of the power converting devices, which may cause the power converting devices VSC1 to VSCn to become desynchronized. Accordingly, there is a desire to synchronize the switching frequencies f_{sw} of the parallel-connected plurality of power converting devices VSC1 to VSCn to correct and/or reduce the desynchronization of the power converting devices, thereby reducing the magnitude of the total output current ripples and improving the power efficiency and/or reliability of the power converting devices. Consequently, the total cost of the power converting system of one or more of the example embodiments may be reduced by allowing for the use of lower switching frequency, smaller output passive grid filters and/or output grid filters, etc. However, while it is possible to add communication lines between the power converting devices to share information regarding synchronization between the power converting devices, it is not practicable and/or may be undesirable to do so because of decreased reliability due to problems related to increased wiring between the power converting devices, increased cost, and/or increased installation complexity from the addition of communication lines between the power converting devices. Accordingly, there is also a desire for a method to synchronize the switching waveforms, switching node voltages, and/or phases of the switched node voltages, etc., of the connected power converter devices without any communication between the power converting devices in order to decrease and/or minimize the current ripple, or in other words, there is a desire for the independent and/or autonomous phase synchronization of the power converter devices including, for example, using extremum-seeking control, etc.

Therefore, according to at least one example embodiment, a voltage phase shift (Φᵢ, (also referred to as a total voltage phase shift angle, phase shift angle, phase shift, etc.) of each of the power converting devices VSC1 to VSCn may be independently adjusted to reduce and/or minimize the magnitude of the current ripple being injected to the electrical grid.

Referring now to FIG. 3A and FIG. 3B, FIG. 3A illustrates a total current I_{L} corresponding to the summation of the currents output by three power converting devices (e.g., VSC1 to VSC3) when the phase shift angles (Φ₁ to Φ₃ of the switching pulses of the power converting devices are the same (e.g., the phase shifts are set to 0), and FIG. 3B illustrates the current I_{L} when the phase shift angles Φ₁ to Φ₃ (e.g., the switching pulse phases) of the switching pulses of the power converting devices are offset to improved and/or optimized phase shift offsets.

For example, according to at least one example embodiment wherein the power converting devices are parallel-connected at their outputs and the power converting devices of the power converting system are balanced, e.g., all of the power converting devices have the same input voltages and the same switch duty cycles, the phase shift angle Φᵢ between each of the power converting devices of the system may be determined based on the following equation:

$${Φ}_{i} = 2 π / n , \qquad [ Equation 1 ]$$

where n is the number of parallel-connected power converting devices in the system. For example, where n=3, the differences in the phase shift angles may be Φ₁=0, Φ₂=−2π/3, and Φ₃=2π/3, etc.

As another example, if the number of parallel-connected power converting devices is n=2 (as shown in FIGS. 1A to 1C), the phase shift angles may be Φ₁=0, Φ₂=−2 π/2, etc. However, the example embodiments are not limited thereto, and in systems that are not balanced, other phase shift angles Φᵢ may be used. Additionally, for power converting systems wherein the power converting devices are parallel connected at their inputs, the phase shift angles Φᵢ may be further influenced by other factors, such as topology, loading conditions, etc. However, even for power converting devices which are parallel connected at their inputs, the following methods discussed in connection to FIGS. 4A to 6 may be used to decrease and/or minimize the total current ripple for the respective system.

Referring now to FIG. 3B, the voltage phase shifts of the three power converting devices may be offset by 2π/3, which reduces the magnitude of the output total current I_{L} in comparison to the output total current I_{L} of FIG. 3A, where the three power converting devices have the same voltage phase shift offset.

However, because it is desired that the plurality of power converting devices VSC1 to VSCn do not communicate with each other, one or more of the power converting devices may independently calculate their own voltage phase shift angle, without knowing the number of other power converting devices in the electrical system and/or the phase angles of the other power converting devices in the electrical system. According to at least one example embodiment, one or more of the power converting devices VSC of the electrical system may calculate its own voltage phase shift angle based on a measurement of the voltage ripples and/or current ripples of its input and/or output capacitor, e.g., Cin and/or Con, because the voltage ripple and/or the current ripple may include contributions from the voltage ripples and/or current ripples from all of the power converting devices included in the system. For example, if the plurality of power converting devices are parallel connected at their outputs, each of the power converting devices VSC1 to VSCn may calculate a ripple cost function, e.g., a voltage ripple cost function of the output capacitor Con's, output voltage Vc and/or the current ripple cost function of the output current I_{C}, and may control its own phase of the switching signal based on the ripple cost function value and the switching node voltage phase shift perturbation value (e.g., voltage phase perturbation value), etc. As another example, if the plurality of power converting devices are parallel connected at their inputs, each of the power converting devices VSC1 to VSCn may calculate a ripple cost function, e.g., a voltage ripple cost function of its input capacitor Cin's and/or the current ripple cost function of the input current I_{C}, and may control its phase of the switching signal based on the ripple cost function value and the voltage phase shift perturbation value, etc.

While certain components of a power converting system and a power converting device are shown in FIGS. 1A to 1C and FIG. 2, the example embodiments are not limited thereto, and the power converting system and/or power converting device may include components other than those shown in FIGS. 1A to 1C and FIG. 2, which are desired, necessary, and/or beneficial for operation of the underlying power converting system, electrical system, and/or power converting device, such as monitoring equipment, energy storage equipment, etc.

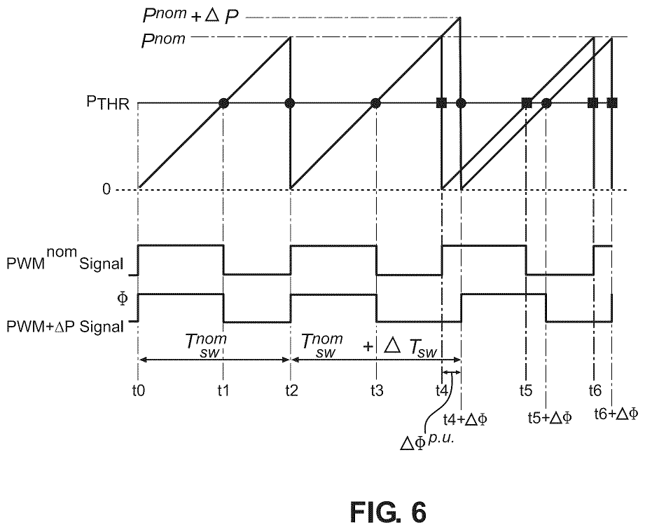

FIG. 4A illustrates an example functional block diagram of the controller of a power converting device according to some example embodiments. FIG. 4B illustrates a voltage ripple sensing circuit according to some example embodiments. FIG. 4C illustrates a current ripple sensing circuit according to some example embodiments. FIG. 4D illustrates an example functional block diagram of the power converting system according to some example embodiments. FIGS. 5A and 5B are flowcharts illustrating an example method of operating the power converting system according to at least one example embodiment. FIG. 6 is an example timing diagram for a PWM control signal according to at least one example embodiment. The following descriptions assume that the plurality of power converting devices are parallel connected at their output terminals, but the example embodiments are not limited thereto, and a person of ordinary skill in the art would easily understand that the discussions herein may be equally applied to a plurality of power converting devices that are parallel connected at their input terminals and/or parallel connected at both their input terminals and output terminals.

Referring now to FIGS. 4A and 5A, each of the power converting devices VSC1 to VSCn may further include a controller 110 (e.g., processing circuitry). Each of the controllers 110, e.g., 110₁ to 110n, may control the operation of the one or more switches of its respective VSC, e.g., SW1 to SW4, using one or more control signals in order to control and/or adjust the phase of the switching signal (e.g., adjust the switching pulse phase, adjust the PWM pulse, and/or adjusting the switched node Voltage Vx) of their respective power converting devices based on phase shift calculations. By adjusting the phase of the switched node voltage, the controllers 110 may control, change and/or adjust the phase shift angle of the switched node voltages of their respective VSC (e.g., Vx1 to Vxn), thereby decreasing and/or minimizing the magnitude of the ripples in the voltage output and/or current output by the input and/or output capacitors of the VSCs, e.g., Vdc, Vc, Idc, and/or I_{C}.

Additionally, or alternatively, according to some example embodiments, a single power converting device, such as VSC1, may have a fixed switching frequency f_{sw}, and a fixed switching pulse phase (e.g., a pulse shift of 0 degrees) and the remaining N−1 power converting devices may perform the method of FIG. 5A to independently determine their total phase shifts Φᵢ. Or put another way, N power converting devices VSC may perform the operations of FIG. 5A, while an N+1th power converting device may have a fixed pulse phase (e.g., a fixed pulse shift).

In at least one example embodiment, the controller 110 may include sensing and acquisition (S&A) circuitry 2010, an alternating current (AC) root-mean-square (RMS) calculator 2030, extremum seeking algorithm circuitry 2040, and/or pulse-width-modulation (PWM) phase change circuitry 2050, etc., but is not limited thereto. Additionally, the S&A circuitry 2010 may include at least one sensing circuitry 2011, a first switch 2012, buffer memory 2020, and/or a second switch 2021, etc., but is not limited thereto. According to some example embodiments, the S&A circuitry 2010, the AC RMS calculator 2030, the extremum seeking algorithm circuitry 2040, and/or the PWM phase change circuitry etc., may be implemented as processing circuitry and/or modules included in the controller 110, separate processing circuitry, and/or may be implemented as special purpose program code executed by the controller 110, etc., but the example embodiments are not limited thereto.

Further, as shown in FIG. 4B, when the controller 110 and/or the S&A circuitry 2010 are configured to sense ripples in the output voltage Vc from a capacitor 2131, which may correspond to the output capacitor Con of FIGS. 1A and 1C and/or the input capacitor Cin of FIGS. 1B and 1C, etc., the S&A circuitry 2010 may further include a high-pass filter (HPF) 2132 to remove and/or decrease a direct current (DC) bias from the voltage ripple, or in other words, the HPF 2132 may extract the voltage ripple RMS value from a voltage signal measurement of the capacitor 2131, but the example embodiments are not limited thereto. In other example embodiments, as shown in FIG. 4C, when the controller 110 and/or the S&A circuitry 2010 are configured to sense ripples in an output current Ic from a capacitor 2131, which may correspond to the output capacitor Con of FIGS. 1A and 1C and/or the input capacitor Cin of FIGS. 1B and 1C, the S&A circuitry 2010 may receive the current signal measurement directly from the capacitor, with or without additional filtering, because the current signal does not suffer from a DC-bias, but the example embodiments are not limited thereto. Moreover, because the values of the output voltage Vc and the output current Ic of the capacitor 2131 are inversely related, the controller 110 and/or S&A circuitry 2010 may convert a current measurement to a voltage measurement or vice versa.

According to at least one example embodiment, the sensing circuitry 2011 may measure and/or obtain a local electrical signal measurement, such as the output current Ic and/or the output voltage Vc for parallel connected output power converting devices VSC1 to VSCn and/or output current Idc and/or output voltage Vdc for parallel connected input power converting devices VSC1 to VSCn, associated with the plurality of power converting devices VSC1 to VSCn, but the example embodiments are not limited thereto. For example, if the power converting devices VSC1 to VSCn are parallel connected at their outputs, the output voltage Vc may be considered a local target electrical signal measurement (e.g., a desired electrical measurement, etc.) associated with the plurality of power converting devices VSC1 to VSCn, since the voltage Vc will be the same (or very close to being the same) for each of the power converting devices because the plurality of power converting devices are connected in parallel. Additionally, in some other example embodiments, the output current I_{L} may be considered the local target electrical signal measurement associated with the plurality of power converting devices VSC1 to VSCn and the output current I_{L} may be the summation of the current I_{C} of the plurality of power converting devices connected in parallel. However, the example embodiments, are not limited thereto, and for example, the input voltage and/or the input current may be used as the local target electrical signal measurement for systems where the plurality of power converting devices VSC1 to VSCn are parallel connected at their inputs.

For the sake of clarity and brevity, the operations of FIG. 5A will be discussed with respect to the system of FIG. 1A, wherein the plurality of power converting devices VSC1 to VSCn are parallel connected at only their outputs and the voltage Vc is the target electrical signal measurement, but the example embodiments are not limited thereto, and the output current, input voltage, and/or the input current may be used as the target electrical signal measurement according to some other example embodiments.

In operation S510, the controller 110 may sample and/or oversample the voltage Vc using the switch 2012. The voltage Vc may be sampled and/or oversampled at a sampling frequency calculated using the following equation:

$${f}_{o v s} = Ns * {f}_{s w} \qquad [ Equation 2 ]$$

where fₒᵥₛ is the sampling frequency; Ns is the desired number of samples per switching period; and f_{sw} is the switching frequency of the VSC.

According to some example embodiments, the desired number of samples per switching period Ns is any number of samples per switching period the controller 110 is capable of supporting, for example, Ns may be set to greater than 16, but is not limited thereto. Further, the sampled voltage may be stored by the controller 110 in the buffer memory 2020 of the controller 110 and/or the VSC. For example, the controller 110 may store the sampled voltage in the buffer memory via a direct memory access (DMA) operation in order to avoid interrupting the controller 110 upon each sampling instance, but the example embodiments are not limited thereto.

At operation S520, the controller 110 and/or the buffer memory 2020 may generate an interrupt signal using a switch 2021 at a rate using the following equation, but the example embodiments are not limited thereto:

$${f}_{c} = Nc * {f}_{s w} \qquad [ Equation 3 ]$$

where f_{c} is the interrupt frequency; Nc is the desired number of interrupts per switching period; and f_{sw} is the switching frequency of the VSC. For example, the interrupt f_{c} frequency may be set to equal the f_{sw} or set to double the f_{sw} but is not limited thereto.

According to some example embodiments, the generated interrupts may coincide with and/or be used to perform other operations of the controller 110 and/or the VSC, such as performing power flow control of the VSC, etc. For example, the desired number of interrupts per switching period Nc may be set so that the controller 110 is interrupted once or twice during the switching period T_{sw}, but the example embodiments are not limited thereto.

In operation S530, the controller 110 may calculate a ripple cost function value yₙ using the buffered voltage samples of Vc, but is not limited thereto. For example, the controller 110 and/or the AC RMS calculator 2030 may perform an AC RMS calculation on the buffered voltage Vc samples to calculate the ripple cost function value yₙ, but the example embodiments are not limited thereto, and for example, the controller 110 may calculate a ripple peak value, a squared RMS value, etc., of the buffered voltage Vc samples to calculate the ripple cost function yₙ, etc.

In operation S540, the controller 110 may calculate and/or obtain an instantaneous phase shift perturbation value ϕᵢ (e.g., phase perturbation value, etc.) corresponding to the respective PWM phase using the following equation:

$${ϕ}_{i} = {A}_{i} sin ( {w}_{i} t ) \qquad [ Equation 4 ]$$

where Aᵢ=a magnitude of the perturbation; wᵢ=perturbation angular frequency; and t=time.

While Equation 4 uses a sinusoidal wave function, the example embodiments are not limited thereto, and for example, other waveform functions may be used, such as a triangular waveform, a square waveform, a trapezoidal waveform, etc.

According to some example embodiments, an initial instantaneous PWM phase shift perturbation value ϕᵢ may be a set value for an initial and/or first execution of the method of FIG. 5A (e.g., used during the system start-up, etc.), and is re-calculated and/or updated upon each execution of the method of FIG. 5A by the power converting device VSC. For example, each power converting device VSC may be set and/or configured with a different initial instantaneous PWM phase shift perturbation value ϕᵢ by the manufacturer of the power converting device VSC, an operator of the power converting device VSC, etc., but the example embodiments are not limited thereto.

In operation S550, the controller 110 and/or the extremum seeking algorithm circuitry 2040 may determine the desired total phase shift of the VSC (Di using an extremum seeking algorithm. The extremum seeking algorithm circuitry 2040 may be used to determine the correlation between the power converting device's PWM phase shift perturbation value ϕᵢ and the resulting voltage Vc ripple cost function (e.g., the value of the output of the AC RMS calculation, etc.), by calculating, obtaining, and/or determining a gradient map of the ripple cost function in real-time and/or near-real-time and measuring its response to the set PWM phase shift perturbation value ϕᵢ. The calculation of the extremum seeking algorithm will be discussed in greater detail in connection with FIGS. 4B and 5B.

Once the response to the PWM phase shift perturbation value ϕᵢ is calculated, in operation S560, the controller 110 and/or PWM phase change circuitry 2050 may generate a PWM control signal based on the PWM phase shift perturbation value ϕᵢ (and/or adjust the pulse phase of the PWM control signal), and may transmit the PWM control signal to the switches (e.g., switches SW1 to SW4, etc.) of the VSC to control the phase of the switching voltage of the VSC, thereby steering and/or directing the switched node voltage phases of the VSCs (e.g., Vx1 to Vxn), output by the VSCs, to the desired total phase shift Φᵢ of the VSC, thereby decreasing and/or minimizing the magnitude of the ripples in the voltage Vc output by the VSCs, similar to the magnitude of the ripples shown in FIG. 3B.

Referring now to FIG. 6, the controller 110 and/or PWM phase change circuitry 2050 may control the phase of the switching voltage of the power converting device VSC using, for example, a triangular PWM control signal (e.g., PWM carrier waveform, PWM carrier, etc.), where T_{sw}=1/f_{sw}, but the example embodiments are not limited thereto and other types of PWM control signals may be used. As shown in FIG. 6, at time t0, a rising edge of an “on” period of a nominal switching voltage (e.g., PWM signal) may correspond to when the voltage of the PWM control signal is at a valley (e.g., 0V, etc.), and at time t1, a falling edge of the “on” period may correspond to a time when the voltage of the PWM control signal reaches a modulating waveform and/or a target duty cycle (e.g., a desired threshold voltage level, a minimum threshold voltage level, etc.), and the switching signal begins its “off” period. At time t2, the PWM control signal reaches its nominal maximum voltage level, e.g., Pnom, and falls (e.g., to 0V, etc.), which ends the “off” period of the duty cycle and begins the next “on” period of the switching signal.

However, based on the results of operation S560, the controller 110 and/or PWM phase change circuitry 2050 may transmit a corrective PWM control signal to the switches of the power converting device VSC, wherein the magnitude of the PWM control signal is increased or decreased by a ΔP value, where ΔP determines the desired total phase shift increment to be applied to the switching node voltage, the PWM pulse, and/or the switching waveform, etc. The ΔP may be calculated using the following equation:

$$( Δ P / Pnom ) = ( Δ {Φ}^{p . u .} / 1 ) \qquad [ Equation 5 ]$$

where ΔΦ^{p.u.} is a relative value of difference between two latest algorithm calculations (total phase shifts) going from 0 to 1 (e.g., relative to the switching period T_{sw}), and where p.u. stands for per-unit normalization of the angle with respect to the switching period T_{sw}.

By increasing the magnitude of the PWM control signal by ΔP, the controller 110 and/or PWM phase change circuitry 2050 may increase the “off” period of the switching period T_{sw} as shown at time t4+ΔΦᵢ. On the next pulse of the PWM control signal, the magnitude of the PWM control signal may return to Pnom, thereby returning the T_{sw} to its original value, but having the PWM pulse shift by the desired total phase shift increment value ΔΦᵢ.

While FIG. 6 illustrates a triangular PWM waveform with a trailing edge (e.g., an up-count sawtooth carrier), the example embodiments are not limited thereto, and for example, the controller 110 and/or PWM phase change circuitry 2050 may generate a triangular PWM waveform with a leading edge (e.g., a down-count sawtooth carrier), a double-edge triangular waveform (e.g., an up-down count symmetrical triangular carrier), etc.

Returning now to FIGS. 4A and 5A, the controller 110 and/or PWM phase change circuitry 2050 may generate PWM switching signals (e.g., square pulse signals, etc.) based on the PWM control signal, and may apply the PWM switching signals to the switches of the power converting device VSC. The controller 110 may then return to operation S510 and continue to monitor the ripple in the voltage Vc and adjust the total phase shift Φᵢ in order to reduce and/or minimize the voltage ripple in the power converting system.

While FIG. 5A illustrates the operation of a single controller 110, one or more of the controllers 110 of the plurality of power converting devices VSC1 to VSCn will independently perform the operations of FIG. 5A in order to independently and/or autonomously reduce and/or minimize the voltage ripple in its output voltage Vc. However, the example embodiments are not limited thereto, and for example, the controllers 110 of the plurality of power converting devices VSC1 to VSCn may independently and/or autonomously reduce and/or minimize a current ripple in the current I_{C}, etc. In some example embodiments, all of the controllers 110 of the plurality of power converting devices VSC1 to VSCn may independently perform the operations of FIG. 5A, but the example embodiments are not limited thereto. In other example embodiments, one or more of the controllers 110 of the plurality of power converting devices may have fixed switching signal phase shifts and the remaining power converting devices may monitor and control their total phase shifts Φᵢ, etc.

Referring now to FIGS. 4B and 5B, the determination of the total phase shift of one or more of the power converting devices VSC2 to VSCn using the extremum seeking algorithm will be described in greater detail. In FIG. 4B, it is assumed that power converting device VSC1 has a fixed switching pulse phase and the power converting devices VSC2 to VSCn may monitor and control their total phase shifts Φᵢ, but the example embodiments are not limited thereto, and for example, all of the power converting devices VSC1 to VSCn may monitor and control their total phase shifts Φᵢ.

In operation S551, each of the controllers 110₂ to 110_{N} will receive ripple cost function values y₂ to yₙ from the respective AC RMS calculators 2030₂ to 2030ₙ and may demodulate (e.g., multiply) the ripple cost function values y₂ to yₙ using a demodulator 2052 based on the voltage phase shift perturbation value ϕ₂ to ϕₙ and a scaling factor corresponding to a perturbation magnitude from function 2051, wherein the perturbation magnitude may be set to define a convergence speed of an improved and/or optimum phase for the target electrical signal measurement. In other words, the demodulator 2052 may extract a frequency component from the ripple cost function values y₂ to yₙ based on the scaled voltage phase shift perturbation values ϕ₂ to ϕₙ in order to see the impact of the voltage phase shift perturbation of the respective VSC and not the impact of the voltage phase shift perturbations from the other VSCs.

In operation S552, each of the controllers 110₂ to 110_{N} may filter the demodulated ripple cost function values y₂ to yₙ using a filter 2053 to attenuate undesired spectral components from the demodulated signal. According to at least one example embodiment, the filter 2053 may be at least one of a moving average filter, a low-pass filter, a notch filter, and/or a bandpass filter, etc. For example, the filter 2053 may be a moving average filter with an averaging window set to the period of the voltage phase shift perturbation value ϕ₂ to ϕₙ.

In operation S553, each of the controllers 110₂ to 110_{N} may compensate the filtered and demodulated cost function value using the compensator 2054 in order to have the system converge and increase stability, thereby obtaining a slowly varying phase shift Φ̅ᵢ. For example, the compensator 2054 may perform an integral control and apply a compensation gain kc to the filtered and demodulated cost function value, which changes the convergence speed of the cost function value, and steers the phase trajectory to be closer to (or equal to) a phase trajectory which results in a reduced and/or minimal voltage ripple (and/or current ripple) AC RMS value. However, the example embodiments are not limited thereto, and for example, compensator 2054 may perform a proportional control, a proportional-integral control, proportional-integral-derivative control, a non-linear control, etc., on the filtered and demodulated cost function value.

In operation S554, each of the controllers 110₂ to 110_{N} may determine the total phase shift values Φ₂ to Φ_{N} by subtracting the slowly varying phase shift Φ̅₂ to Φ̅_{N} from the phase shift perturbation value ϕ₂ to ϕₙ. Next, each of the controllers 110₂ to 110_{N} may generate and/or adjust a PWM control signal based on the determined total phase shift values Φ₂ to Φ_{N}, e.g., by determining the difference between the total phase shift values Φ₂ to Φ_{N} and the previous total phase shift values Φ₂ to Φ_{N} of the previous interrupt instance. The controllers 110₂ to 110_{N} may generate PWM switching signals based on the PWM control signals and may apply the PWM switching signals to the switching nodes of the respective power converting devices VSC2 to VSCn, etc.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A power converting system comprising:
a plurality of power converting devices electrically connected to each other in parallel, each of the plurality of power converting devices including at least one switching node and each of the plurality of power converting devices connected to at least one capacitor; and
a plurality of controllers each connected to the plurality of power converting devices, each of the plurality of controllers configured to,
sample a targeted local electrical signal measurement associated with an electrical signal of the plurality of power converting devices electrically connected to each other in parallel over a desired time period,
obtain a cost function value associated with the plurality of power converting devices electrically connected to each other in parallel based on the samples of the targeted local electrical signal measurement,
obtain a phase perturbation value associated with the at least one switching node of the connected power converting device, and
adjust a switching pulse phase of the connected power converting device based on the cost function value and the phase perturbation value.

2. The system of claim 1, wherein the targeted local electrical signal measurement is a measurement of a voltage ripple of the at least one capacitor of the plurality of power converting devices.

3. The system of claim 2, further comprising:
a filter connected to the at least one capacitor of the plurality of power converting devices, the filter configured to remove a DC-bias from the electrical signal; and
wherein each of the plurality of controllers are further configured to,
sample the filtered electrical signal.

4. The system of claim 1, wherein the targeted local electrical signal measurement is a measurement of a current ripple of the at least one capacitor of the plurality of power converting devices.

5. The system of claim 1, wherein each of the plurality of power converting devices include at least one output port, and the plurality of power converting devices are electrically connected to each other in parallel at the at least one output ports.

6. The system of claim 1, wherein each of the plurality of power converting devices include at least one input port, and the plurality of power converting devices are electrically connected to each other in parallel at the at least one input ports.

7. The system of claim 1, wherein each of the plurality of power converting devices include at least one output port and at least one input port, and the plurality of power converting devices are electrically connected to each other in parallel at the at least one output ports and the at least one input ports.

8. The system of claim 1, wherein each controller of the plurality of controllers is further configured to adjust the switching pulse phase of the connected power converting device by:
multiplying the cost function value with the phase perturbation value;
filtering results of the multiplication; and
performing compensation on results of the filtering.

9. The system of claim 8, wherein each controller of the plurality of controllers is further configured to perform compensation on the filtered and demodulated cost function value by performing at least one of:
integral control on the results of the filtering, proportional control on the results of the filtering, proportional-integral control on the results of the filtering, proportional-integral-derivative control on the results of the filtering, non-linear control on the results of the filtering, or any combinations thereof.

10. The system of claim 8, wherein each controller of the plurality of controllers is further configured to filter the results of the multiplication using at least one of:
a moving average filter, a low-pass filter, a notch filter, a bandpass filter, or any combinations thereof.

11. The system of claim 8, wherein each controller of the plurality of controllers is further configured to adjust the switching pulse phase of the connected power converting device by:
determining a total phase shift associated with the at least one switching node of the connected power converting device based on the phase perturbation value and results of the compensating.

12. The system of claim 11, wherein each controller of the plurality of controllers is further configured to adjust the switching pulse phase of the connected power converting device by:
adjusting the switching pulse phase of at least one terminal of the connected power converting device based on the determined total phase shift.

13. The system of claim 12, wherein each controller of the plurality of controllers is further configured to adjust the switching pulse phase of the connected power converting device by:
obtaining a previous switching pulse phase of the at least one terminal of the connected power converting device; and
adjusting the switching pulse phase of the at least one terminal of the connected power converting device based on the determined total phase shift and the obtained previous switching pulse phase.

14. The system of claim 11, wherein
the plurality of controllers is equal to N controllers, wherein N is an integer greater than or equal to 1;
the plurality of power converting devices is equal to N power converting devices; and
the system further comprises,
an N+1th power converting device connected to the plurality of power converting devices, the N+1th power converting device including at least one N+1th switching node, and
an N+1th controller connected to the N+1th power converting device, the N+1th controller configured to provide a fixed switching pulse phase to the at least one N+1th switching node.

15. The system of claim 1, wherein the plurality of power converting devices are at least one of:
voltage source converters, voltage source inverters, current source inverters, AC-DC converters, DC-DC converters, DC-AC converters, AC-AC converters, or any combinations thereof.

16. The system of claim 1, further comprising:
a plurality of photovoltaic (PV) modules connected to a corresponding power converting device of the plurality of power converting devices, each of the PV modules configured to,
harvest solar energy, and
output the harvested solar energy as direct current (DC) power to the corresponding power converting device; and
each of the plurality of controllers are further configured to,
sample the targeted local electrical signal measurement associated with the plurality of power converting devices from the DC power.

17. A method of operating a power converting system comprising:
sampling a targeted local electrical signal measurement associated with an electrical signal of a plurality of power converting devices over a desired time period, the plurality of power converting devices electrically connected to each other in parallel, each of the plurality of power converting devices including at least one switching node and each of the plurality of power converting devices connected to at least one capacitor;
obtaining a cost function value associated with the plurality of power converting devices electrically connected to each other in parallel based on the samples of the targeted local electrical signal measurement;
obtaining phase perturbation values associated with each of the at least one switching nodes of the plurality of power converting devices; and
adjusting a switching pulse phase of each power converting device of the plurality of power converting devices based on the cost function value and the phase perturbation value associated with the power converting device.

18. The method of claim 17, wherein the adjusting the switching pulse phase of each of the power converting devices further includes:
multiplying the cost function value associated with each of the power converting devices with the phase perturbation value associated with the power converting device;
filtering results of the multiplying associated with each of the power converting devices; and
performing compensation on results of the filtering associated with each of the power converting devices.

19. The method of claim 18, wherein the adjusting the switching pulse phase of each power converting device of the plurality of the power converting devices further includes:
determining a total phase shift associated with the at least one switching node of each of the power converting devices based on the phase perturbation value associated with each of the converting devices and results of the compensating associated with each of the power converting devices.

20. A photovoltaic (PV) power converting system, the system comprising:
a plurality of power converting devices connected to a plurality of photovoltaic (PV) modules, the plurality of power converting devices electrically connected to each other in parallel, each of the plurality of power converting devices including at least one switching node and each of the plurality of power converting devices connected to at least one capacitor; and
a plurality of controllers each connected to the plurality of power converting devices, each of the plurality of controllers configured to,
sample a targeted local electrical signal measurement associated with an electrical signal of the plurality of power converting devices electrically connected to each other in parallel over a desired time period,
obtain a cost function value associated with the plurality of power converting devices electrically connected to each other in parallel based on the samples of the targeted local electrical signal measurement,
obtain a phase perturbation value associated with the at least one switching node of the connected power converting device, and
adjust a switching pulse phase of the connected power converting device based on the cost function value and the phase perturbation value.
